(19) United States
(12) Patent Application Publication
(10) Pub. No.: US 2022/0113353 A1
(43) Pub. Date: Apr. 14, 2022

(54) INPUT-OUTPUT DEVICE WITH DEBUG CONTROLLER

(71) Applicants: Aruni P. Nelson, Folsom, CA (US); Abdul R. Ismail, Beaverton, OR (US); Ashok Mishra, Portland, OR (US); Enrico David Carrieri, Placerville, CA (US); Ilya Wagner, Hillsboro, OR (US)

(72) Inventors: Aruni P. Nelson, Folsom, CA (US); Abdul R. Ismail, Beaverton, OR (US); Ashok Mishra, Portland, OR (US); Enrico David Carrieri, Placerville, CA (US); Ilya Wagner, Hillsboro, OR (US)

(21) Appl. No.: 17/645,831

(22) Filed: Dec. 23, 2021

(51) Int. Cl. G01R 31/317; G01R 31/28; G01R 31/3183

(52) U.S. Cl. CPC G01R 31/31715; G01R 31/3183; G01R 31/2839; G01R 31/31705

(57) ABSTRACT

In an embodiment, an input-output (IO) device may include an IO controller and a debug controller. The IO controller may process IO data packets. The debug controller may be to: receive a first debug packet from a host system via an in-band connection, process the first debug packet to extract a command generated by the host system, and execute the extracted command to debug the IO device. Other embodiments are described and claimed.

### BACKGROUND

In many computer systems, peripheral devices may be connected to the computing systems using communication links. The communication links may implement a bus protocol, such as one of the universal serial bus (USB) family of bus protocols.

### BRIEF DESCRIPTION OF THE DRAWINGS

FIGS. 1A-1B are block diagrams of example systems in accordance with one or more embodiments.

FIG. 2 is a flow diagram of an example method in accordance with one or more embodiments.

FIGS. 3A-3C are block diagrams of an example devices in accordance with one or more embodiments.

FIGS. 4A-4B are block diagrams of example systems in accordance with one or more embodiments.

FIG. 5 is a flow diagram of an example method in accordance with one or more embodiments.

FIG. 6 is a flow diagram of an example method in accordance with one or more embodiments.

FIG. 7 is a block diagram of an example system in accordance with one or more embodiments.

FIG. 8 is an illustration of an example storage medium in accordance with one or more embodiments.

### DETAILED DESCRIPTION

In some computer systems, a host device may be coupled to one or more peripheral devices via communication links. For example, a system may include a host computer connected to multiple input-output (IO) devices via a Universal Serial Bus (USB) link. Each IO device may include a controller to process IO data packets that are received or sent via the link. For example, an IO controller may be a simplified processor that executes firmware that is specific for the function of the IO device. The main data link that transfers IO data packets between the host device and the IO device may be referred to as an “in-band” link. Further, a data link that is distinct and/or separate from the in-band main link may be referred to as an “out-of-band” link.

In some examples, development and/or modification of such computer systems may include performing “debugging,” or identifying problem in hardware or software of the system. Debugging of the host system may include executing debug software on the host system, which may provide run-control capability for source level debug (e.g., to pause execution of a program at a specific breakpoint). However, debugging a system that includes a connected IO device may involve additional complexity and cost. For example, the debug software that executes on the host system may have in-band access to the IO device, but may lack run-control capability for firmware executing on IO device. Further, hardware-based debug tools may be used for run-control capability, but may require physically connecting (e.g., soldering) to connector pins of the IO controller, or connecting to additional physical ports that are dedicated for debug use. Therefore, such hardware-based debug tools may only provide out-of-band debugging, which may involve significant cost and/or complexity.

In various embodiments described herein, an IO device may include a debug controller or function to provide in-band debugging of the IO device. For example, the debug controller may receive debug packets including debug commands from a host system via an in-band connection. As used herein, the term “debug packet” refers to a packet that is dedicated for use in the debug process. The debug controller may extract the command from the received packet, and may then execute the command to perform debug actions in the IO device. For example, such debug actions may include debugging various components or capabilities of the IO device, performing run-control for source level debug, accessing onboard debug trace capabilities, accessing telemetry data, and so forth. The debug controller may obtain the results of the executed command, encapsulate the results in another debug packet, and transmit the debug packet to the host system via the in-band connection. Upon receiving the debug packet, the host system may extract the results from the debug packet, and may use the results in the debugging process. In this manner, some embodiments may provide in-band debugging of IO devices that includes run-control capabilities. Accordingly, one or more embodiments may perform advanced debug actions without requiring separate out-of-band connections or device modifications, and may therefore reduce the cost and complexity associated with debugging IO devices.

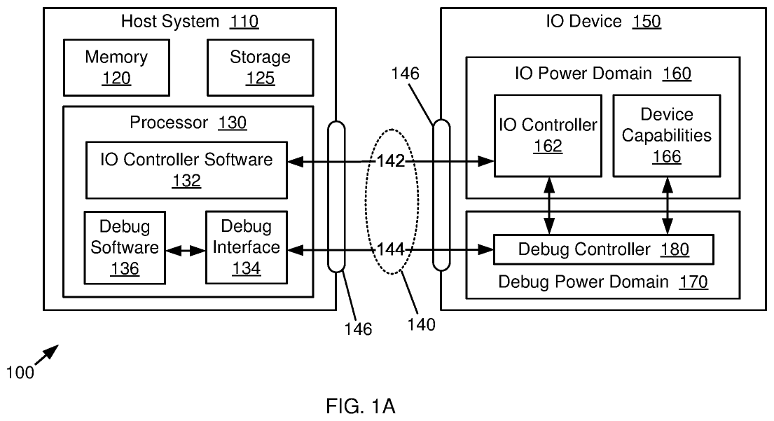

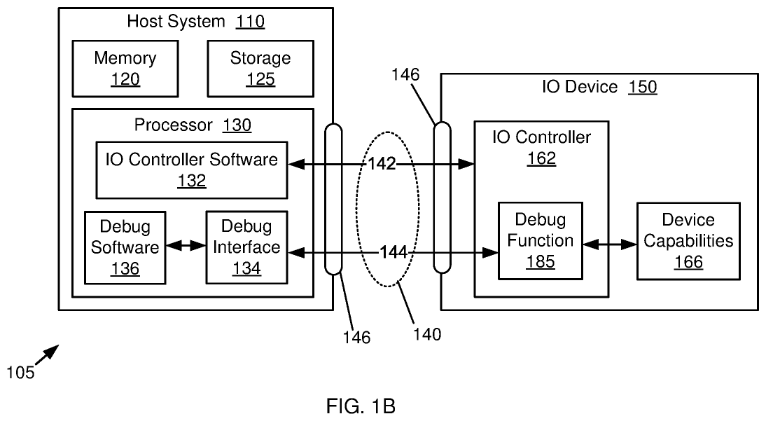

FIGS. 1A-1B—Example Systems

Referring now to FIG. 1A, shown is a block diagram of a first example system 100 in accordance with one or more embodiments. The system 100 may include a host system 110 connected to an input-output (IO) device 150 via a link 140. The host system 110 may be a computing device (e.g., a server, a desktop computer, a laptop, a handheld computer, etc.). The IO device 150 may be a peripheral device connected to the host system 110. As used herein, an “IO device” refers to any device providing input and/or output to a connected computing device (e.g., host system 110). For example, an IO device may refer to a USB hub, a USB device, and so forth.

As shown in FIG. 1A, the host system 110 may include memory 120, storage 125, a processor 130, and a port 146. In some embodiments, the memory 120 can be implemented with any type(s) of computer memory (e.g., dynamic random-access memory (DRAM), static random-access memory (SRAM), non-volatile memory (NVM), a combination of DRAM and NVM, etc.). The storage 125 can be implemented using one or more of persistent (e.g., nonvolatile) storage device(s), such as disk-based storage device(s) (e.g., hard disk drive(s) (HDDs)), solid state device(s) (SSDs) (e.g., flash storage devices), optical disks, and so forth. The processor 130 may be a hardware processing device (e.g., a central processing unit (CPU), a System on a Chip (SoC), and so forth), and may include any number of processing circuits or “cores.” The port 146 may be an IO communication port (e.g., a USB port) to transfer data units (e.g., packets) across a link.

In some embodiments, the processor 130 may execute various software including IO controller software 132, debug interface 134, and debug software 136. The IO controller software 132 may send IO data packets 142 to the IO controller 162 of the IO device 150, and may also receive IO data packets 142 from the IO controller 162 (e.g., via the link 140 and the ports 146). In some embodiments, the IO controller 162 may be a hardware processing device that executes firmware or software instructions to send and receive IO data packets 142, and to control the IO device 150 and its device capabilities 166. The device capabilities 166 may include various hardware and software elements having different functionalities of the IO device 150 (e.g., routing, multiplexing, filtering, protocol conversion, compression, and so forth). The IO data packets 142 may be formatted according to a bus protocol of the link 140.

In some embodiments, the debug software 136 may be executed to perform debugging of the host system 110 and the IO device 150. For example, the debug software 136 may analyze items such as data, instructions, registers, buffers, and so forth. Further, the debug software 136 may determine one or more debug actions that are needed for the debug process (e.g., pausing execution, reading variable values, etc.), and may issue commands to cause the debug actions to be performed in the host system 110 and/or the IO device 150.

In some embodiments, the debug interface 134 may encapsulate a command from the debug software 136 in a debug packet 144. The debug interface 134 may then transmit the debug packet 144 (including the command) to the IO device 150 via the link 140. Further, the debug interface 134 may receive debug packets 144 that include debug results from the IO device 150 (e.g., results of executing commands from the debug software 136), and may extract the debug results from the received debug packets 144. In some embodiments, by using the debug interface 134 to generate outbound debug packet 144 and to process inbound debug packets 144, the host system 110 may perform in-band debugging of the IO device 150 (i.e., without requiring an out-of-band connection). In some embodiments, the debug packets 144 may have a packet type that is dedicated for use in the debug process. Further, in some embodiments, the debug packets 144 may be formatted according to a bus protocol of the link 140.

In one or more embodiments, the debug controller 180 of the IO device 150 may be a hardware control device (e.g., circuit, microcontroller, programmable integrated circuit, programmable gate array, processor, and so forth) that is dedicated for debugging the IO device 150. For example, the debug controller 180 may receive the first debug packet 144 sent by the debug interface 134, may extract the encapsulated command (i.e., generated by the debug software 136), and may then execute the command (e.g., to pause execution, to read variable values, etc.). In another example, the debug controller 180 may determine or obtain the results of executing the command (e.g., data indicating the state of the IO device 150), encapsulate the results in a second debug packet 144, and then transmit the second debug packet 144 to the host system 110 via the link 140 and the ports 146. Further, the debug interface 134 may receive the second debug packet 144, extract the encapsulated results, and then provide the results to the debug software 136. The debug software 136 may use the results to debug the IO device 150, and/or to debug the combined system including the host system 110 and the IO device 150.

In some embodiments, the IO device 150 may include an IO power domain 160 and a debug power domain 170. The IO power domain 160 may provide electrical power to the IO controller 162 and the device capabilities 166. Further, the debug power domain 170 may provide electrical power to the debug controller 180, and may operate independently of the IO power domain 160. For example, the debug power domain 170 may remain powered while the IO power domain 160 is not powered. In this manner, the debug controller 180 may continue to perform debugging while the IO controller 162 is reset by being powered down and then up. Further, the IO power domain 160 may remain powered while the debug power domain 170 is not powered.

In one or more embodiments, the IO device 150 may enter a specialized operating mode in which debugging of the IO device 150 is allowed to be performed (referred to as a “debug mode”). For example, the debug controller 180 may only execute debug commands and/or perform debug actions when the IO device 150 has entered the debug mode. In some embodiments, the debug actions performed by the debug controller 180 may include accessing all entities that can be debugged in the IO device 150 (e.g., device capabilities 166), providing run-control capability for source level debug, accessing any available onboard debug trace capabilities, and accessing telemetry data (e.g., failure rate, wear analysis, etc.) stored locally in the IO device 150.

In some embodiments, the debug mode may be implemented in response to a request from the host system 110 (e.g., via the link 140). Upon receiving a request to enter the debug mode, the debug controller 180 may determine whether the request is valid and/or authorized. If so, the debug controller 180 may unlock the debug mode (i.e., cause the IO device 150 to operate in the debug mode). For example, the debug mode request may be a secure token that is received and validated by the debug controller 180. The secure token may specify the type of debug (source level, trace, telemetry, etc.) and level of debug access (full unlock, partial unlock, etc.). Further, in other examples, the debug mode request may be implemented using a digital certificate, a challenge/response technique, or any suitable form of cryptographic authentication. In some embodiments, the debug interface 134 may encapsulate the debug mode request in a first debug packet 144. Further, the debug controller 180 may extract the debug mode request from the first debug packet 144.

In one or more embodiments, upon entering the debug mode, the debug controller 180 may send a confirmation via the link 140 to the host system 110. The confirmation may indicate the entry of the IO device 150 into the debug mode. Further, upon receiving the confirmation, the debug software 136 of the host system 110 may generate debug commands to be sent to the IO device 150. In some embodiments, the debug controller 180 may encapsulate the confirmation in a second debug packet 144. Further, the debug interface 134 may extract the confirmation from the second debug packet 144.

Referring now to FIG. 1B, shown is a block diagram of a second example system 105 in accordance with other embodiments. Note that, in the example shown in FIG. 1B, the host system 110 includes the same components and functionality as that described above with reference to the example shown in FIG. 1A. However, the IO device 150 includes a debug function 185, which may be instructions (e.g., firmware or software) executed by the IO controller 162. The debug function 185 may provide some or all of the functionality of the debug controller 180 (described above with reference to FIG. 1A). For example, the debug function 185 may receive a debug packet 144 sent by the debug interface 134, extract an encapsulated command, and execute the command. In another example, the debug function 185 may obtain the results of executing the command, encapsulate the results in a debug packet 144, and transmit the debug packet 144 to the host system 110.

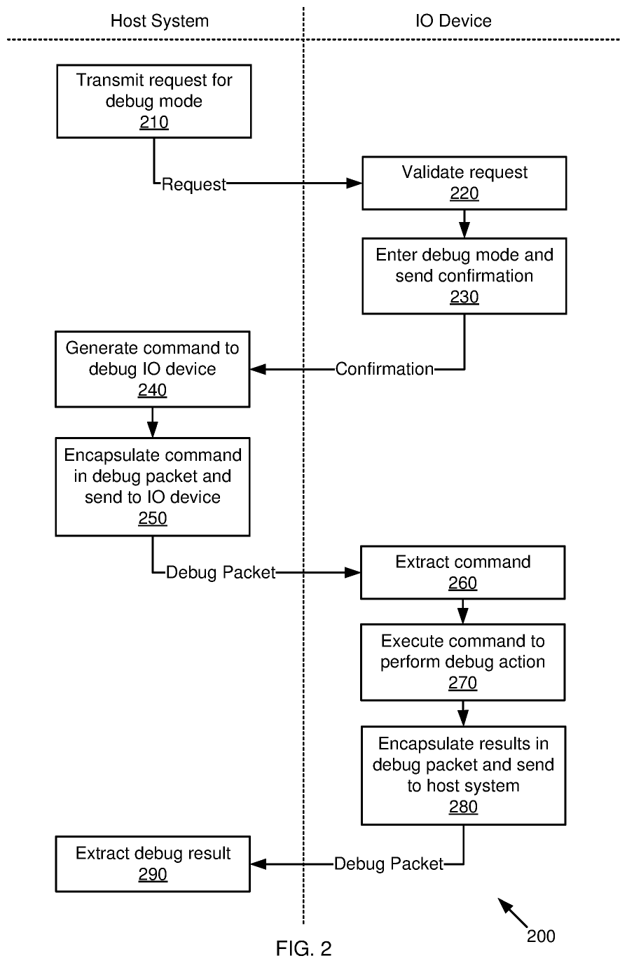

FIG. 2—Example Method

Referring now to FIG. 2, shown is a flow diagram of a method 200, in accordance with one or more embodiments. In various embodiments, the method 200 may be performed by processing logic (e.g., processor 130, input-output (IO) controller 162, debug controller 180, and/or debug function 185 shown in FIGS. 1A-1B) that may include hardware (e.g., processing device, circuitry, dedicated logic, programmable logic, microcode, etc.), software and/or firmware (e.g., instructions run on a processing device), or a combination thereof. In firmware or software embodiments, the method 200 may be implemented by computer executed instructions stored in a non-transitory machine-readable medium, such as an optical, semiconductor, or magnetic storage device. The machine-readable medium may store data, which if used by at least one machine, causes the at least one machine to fabricate at least one integrated circuit to perform a method.

Block 210 may include a host system transmitting a request for a debug mode to an IO device. Block 220 may include the IO device validating the request. Block 230 may include the IO device entering the debug mode, and sending a confirmation to the host system. For example, referring to FIG. 1A, the host system 110 may transmit a debug mode request to the IO device 150 via the link 140. The debug controller 180 may determine that the debug mode request is authorized (e.g., using cryptographic authentication of the request), and in response may unlock the debug mode of the IO device 150. Further, the debug controller 180 may transmit a confirmation of the unlocking of the debug mode to the host system 110. In some embodiments, the debug mode request may be encapsulated in a first debug packet 144. Further, in some embodiments, the confirmation may be encapsulated in a second debug packet 144.

Block 240 may include the host system, upon receiving the confirmation, generating a command to debug the IO device. Block 250 may include the host system encapsulating the command in a debug packet, and sending the debug packet to the IO device. For example, referring to FIG. 1A, the debug software 136 of the host system 110 may receive the confirmation from the IO device 150 via the link 140, and may generate a command to debug the IO device 150. The debug interface 134 may encapsulate the command in a debug packet 144, and may transmit the debug packet 144 to the IO device 150 via the link 140.

Block 260 may include the IO device extracting the command from the debug packet sent by the host system. Block 270 may include the IO device executing the extracted command to perform a debug action in the IO device. For example, referring to FIG. 1A, the debug controller 180 may receive the debug packet 144 from the host system 110, and may extract the command from the received debug packet 144. The debug controller 180 may execute the extracted command to perform a debug action in the IO device 150.

Block 280 may include the IO device encapsulating results of the debug action (i.e., from executing the command) in a debug packet, and transmitting the debug packet to the host system. Block 290 may include the host system extracting the results from the debug packet sent by the IO device. For example, referring to FIG. 1A, the debug controller 180 may determine or obtain data indicating the results of executing the debug command, encapsulate the results in debug packet 144, and transmit the debug packet 144 to the host system 110 via the link 140. Further, the debug interface 134 may receive the debug packet 144, and may extract the debug results from the debug packet 144. In some embodiments, the debug software 136 may use the results to debug the IO device 150, and/or to debug the combined system including the host system 110 and the IO device 150. After block 290, the method 200 is completed.

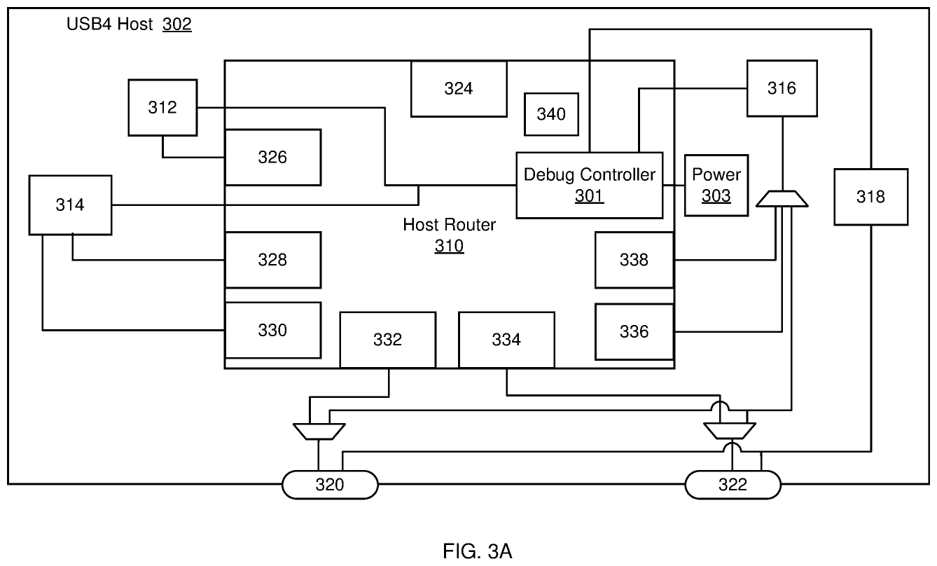

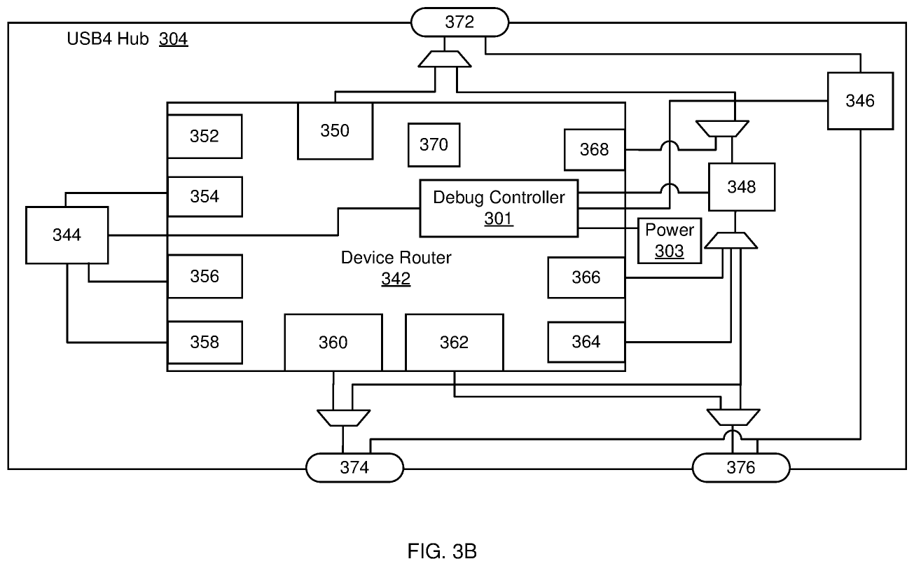

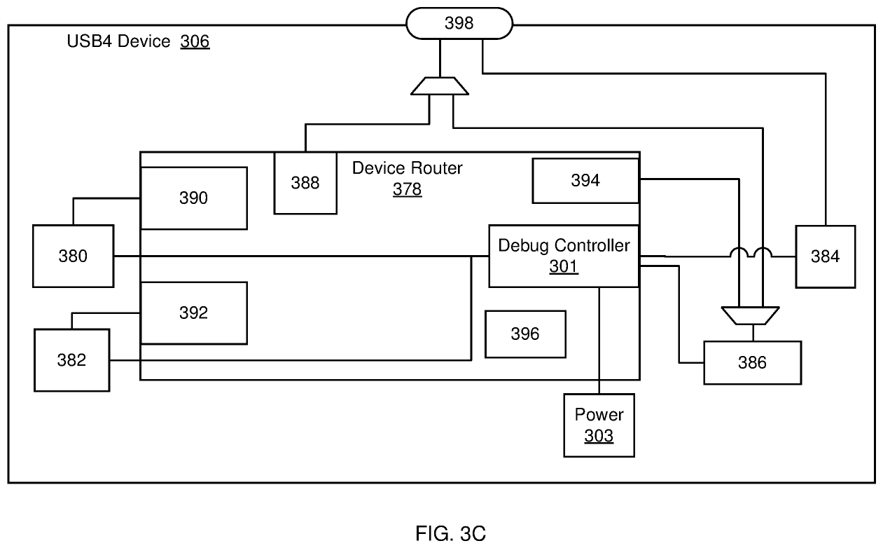

FIGS. 3A-3C—Example Devices

Referring now to FIG. 3A-3C, shown are block diagrams of example devices, namely a Universal Serial Bus 4 (USB4) host 302, a USB4 host, and a USB4 device 306. In some embodiments, some or all of the example devices 302, 304. 306 may correspond generally to example implementations of the input-output (IO) device 150 (shown in FIG. 1A).

In some embodiments, the USB4 host 302 can include a host router 310, an internal host controller, and DisplayPort source 312. The DisplayPort source 312 can be a graphics processor and can include a DisplayPort transmitter (DPTX). The USB4 host 302 can also optionally contain a PCIe controller 314. The PCIe controller 314 can include (or be connected to) a PCIe root complex or PCIe switch complex for controlling PCIe-based routing to one or more peripheral devices. The PCIe controller 314 can be connected to the USB4 host router 310 through one or more PCIe adapters (e.g., PCIe downstream facing adapters 328, 330).

In some embodiments, the USB4 hub 304 can include (or be connected to) a PCIe switch 344 via PCIe upstream facing adapter 354 and PCIe downstream facing adapters 356 and 358. The USB4 device 306 can include a PCIe function 380 that is the PCIe downstream connected component or endpoint device that may communicate with the PCIe controller 314 (e.g., across an USB4 fabric). The USB4 device router 378 can include a PCIe upstream facing adapter 390 to couple the PCIe function 380 with upstream connected components (e.g., USB4 hub 304, PCIe switch 344, and PCIe controller 314).

In some embodiments, the USB4 host 302 can include a USB host router 310. The USB4 hub 304 can include a USB hub router 342. The USB4 device 306 can include a USB device router 378. A router is a building block of the USB4 architecture. A router maps Tunneled Protocol traffic to USB4 packets and routes packets through a USB4 fabric. A router also distributes and synchronizes time throughout the USB4 Fabric via its Time Management Unit (TMU), such as TMU 340, 370, and 396. A router is discovered and configured by a connection manager (e.g., a host interface adapter) 324 located within the USB4 host 302. The router includes a flat point-to-point, configurable switch necessary to create the internal paths between adapters. One router typically exists within each instance of a USB4 host 302, USB4 hub 304, or USB4 device 306. There are two types of Routers: Host Routers and Device Routers.

In some embodiments, the USB4 host 302 can include (or can be connected to) a display port (DP) source 312, such as a graphics processing unit (GPU) or other source of graphics, video, images, etc. The USB4 host router 310 can include a DP_IN adapter 326 that can facilitate an interface to the DP source 312. In embodiments, the DP source can be a USB4 peripheral device or can be connected to the USB4 host router 310 via a DisplayPort-based interconnect (e.g., via a DisplayPort protocol interconnect).

In some embodiments, the USB4 hub 304 can include a DP OUT adapter 352 for outputting DP signaling to a DP sink, such as a display or monitor. The USB4 hub 304 can also transmit DP signaling via a USB4 tunnel to the USB4 device 306. The USB4 device 306 can include a DP OUT adapter 392 for outputting DP signals to a DP sink 382, which can be a display or monitor.

In some embodiments, the internal Enhanced SuperSpeed host 316 may expose one or more Downstream USB3 ports, which can be connected to a USB Endpoint or Downstream USB3 Protocol Adapter. The upstream port of the internal Enhanced SuperSpeed Hub interfaces with an Upstream USB3 Protocol Adapter that forwards packets to the Upstream Facing Port of the USB4 hub 304. In some embodiments, each router may contain up to 64 adapters. Adapters may provide an interface between a router and an external entity. The Adapters may include three types: Protocol Adapters, Lane Adapters, and Control Adapters. A Protocol Adapter is used to translate between a supported native protocol and a USB4 tunnel. There may be four types of Protocol Adapters: USB3 Adapters 336, 338, 364, 366, 368, and 394, DisplayPort (DP) Adapters 326, 352, and 392, PCIe Adapters 328, 330, 354, 356, 358, and 390, and Host Interface Adapters 324. In some embodiments, a router may support an internal Control Adapter that is used solely for transmitting and receiving Control packets to and from the Transport Layer. Unlike the non-Control Adapters, the Control Adapter does not connect directly to a Link and thus does not have a Physical Layer associated with it.

In some embodiments, a USB4 Port may be an entity that provides the USB4 functional interface that resides on each end of a USB4 Link. It may include transmit and receive lanes of the USB4 data bus, along with a two-wire Sideband (SB) Channel (SBTX/SBRX). The USB4 Ports may operate as either a Single-Lane Link or Dual-Lane Link. When operating as a Single-Lane Link, Lane 1 of the USB4 Port is disabled. When operating as a Dual-Lane Link, Lanes 0 and 1 are logically bonded together to provide a single data channel. Example USB4 ports are shown as elements 332, 334, 360, 362, and 388. The USB4 ports can accommodate a USB Type-C connector or Thunderbolt (e.g., TBT3) type connector, etc. In addition to the USB4-specific hub functionality, USB 3.2 and USB 2.0 hub functionality is supported such that Downstream Facing Ports of a USB4 hub can support backward-compatibility with USB 3.2 and USB 2.0 devices. USB 2.0 functionality can be provided via USB 2.0 host 318 connected to a USB 2.0 hub 346 and USB 2.0 function 384.

In some embodiments, each of the USB4 host 302, the USB4 hub 304, and the USB4 device 306 may include one or more USB Type-C connector ports 320, 322, 372, 374, 376, and 398. The USB Type-C connector ports can receive USB Type-C connectors for connected USB compliant components and for transferring information and power between components.

In some embodiments, each of the USB4 host 302, the USB4 hub 304, and the USB4 device 306 may include a debug controller 301 and an associated power domain 303. The debug controller 301 may correspond generally to an example implementation of the debug controller 180 (described above with reference to FIG. 1A). For example, the debug controller 301 may receive a debug packet sent by a host system (e.g., host system 110 shown in FIG. 1A), extract an encapsulated command, and execute the command. The debug controller 301 may also obtain the results of executing the command, encapsulate the results in a debug packet, and transmit the debug packet to a host system. As shown in FIGS. 3A-3B, the debug controller 301 may be connected to various components, and may perform debugging of the various components (e.g., PCIe controller 314, Enhanced SuperSpeed host 316, USB 2.0 host 318, PCIe switch 344, PCIe function 380, and so forth).

In some embodiments, the power domain 303 may provide electrical power to the associated debug controller 301, and may operate independently of the IO device 302, 304, 306. For example, the power domain 303 may allow the debug controller 301 to remain powered and continue to perform debugging while the associated IO device is powered down (e.g., during a restart).

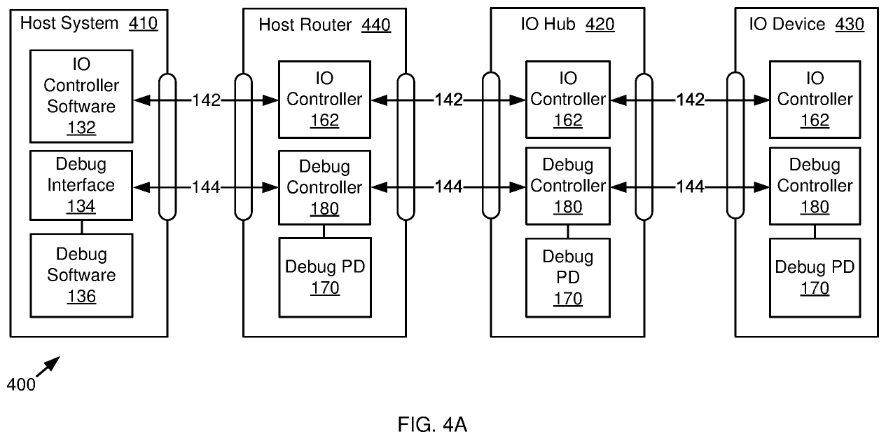

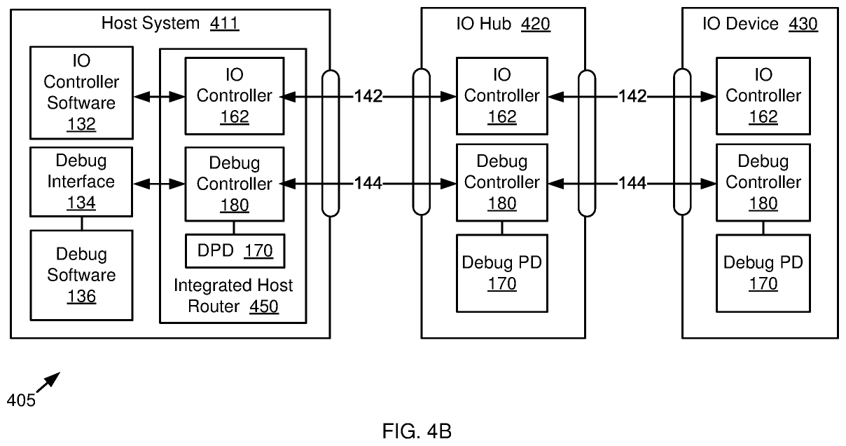

FIGS. 4A-4B—Example Systems

Referring now to FIG. 4A-4B, shown are block diagrams of example systems 400, 405, in accordance with some embodiments. In particular, the systems 400, 405 may include multiple devices 410, 420, 430, 440 connected in a series or chained arrangement. In some embodiments, the host system 410 may correspond generally to an example implementation of the host system 110 (shown in FIG. 1A). Further, some or all of the devices 420, 430, 440 may correspond generally to example implementations of the input-output (IO) device 150 (shown in FIG. 1A).

Referring now to FIG. 4A, shown is a first example system 400 that includes a host system 410, a host router 440, an IO hub 420, and an IO device 430. As shown, the host system 410 may include IO controller software 132, debug interface 134, and debug software 136 (described above with reference to FIG. 1A). Further, the host router 440, IO hub 420, and IO device 430 may each include an IO controller 162, a debug controller 180, and a debug power domain 170 (described above with reference to FIG. 1A).

As shown, in some embodiments, the devices 410, 420, 430, 440 may be connected by an in-band link. Further, the in-band link may be used to send, forward, or receive IO data packets 142 by the various IO controllers 162. The in-band link may also be used to send, forward, or receive debug packets 144 by the various debug controllers 180. For example, the host system 410 may transmit a first debug packet 144 to debug the IO device 430. In some embodiments, the first debug packet 144 may be addressed to the IO device 430. Accordingly, the first debug packet 144 may be forwarded by the host router 440 and the IO hub 420 to the IO device 430. In another example, the host system 410 may transmit a second debug packet 144 to debug the host router 440, and therefore the second debug packet 144 may be addressed to the host router 440. In yet another example, the host system 410 may transmit a third debug packet 144 to debug the entire link path including each of the devices 420, 430, 440. In still another example, the host system 410 may receive other debug packets 144 including results of debug actions performed at any of the device 420, 430, 440.

Referring now to FIG. 4B, shown is a second example system 405 in accordance with other embodiments. Note that, in the example shown in FIG. 4B, the host system 411 includes the IO controller software 132, debug interface 134, and debug software 136. Further, the IO hub 420 and the IO device 430 may each include an IO controller 162, a debug controller 180, and a debug power domain 170. Note that the system 405 does not include the host router 440 (described above with reference to FIG. 4A). Rather, in the system 405 shown in FIG. 4B, the host system 411 may include an integrated host router 450. As shown, the integrated host router 450 may include an IO controller 162, a debug controller 180, and a debug power domain 170. In some embodiments, the host system 411 may be a System on a Chip (SoC) device. Further, the debug software 136 may perform debugging of the integrated host router 450 included in the same host system 411.

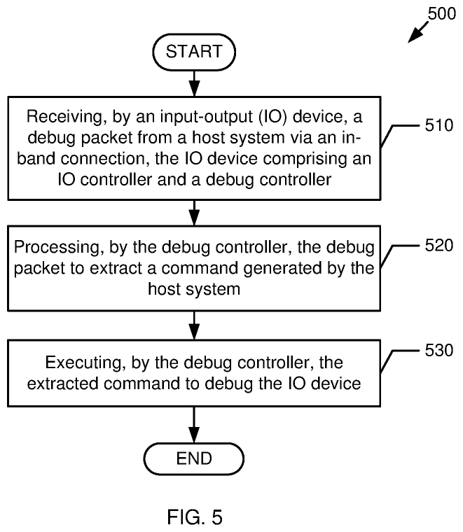

FIG. 5—Example Method

Referring now to FIG. 5, shown is a flow diagram of a method 500, in accordance with one or more embodiments. In various embodiments, the method 500 may be performed by processing logic (e.g., debug controller 180 and/or debug function 185 shown in FIGS. 1A-1B) that may include hardware (e.g., processing device, circuitry, dedicated logic, programmable logic, microcode, etc.), software and/or firmware (e.g., instructions run on a processing device), or a combination thereof. In firmware or software embodiments, the method 500 may be implemented by computer executed instructions stored in a non-transitory machine-readable medium, such as an optical, semiconductor, or magnetic storage device. The machine-readable medium may store data, which if used by at least one machine, causes the at least one machine to fabricate at least one integrated circuit to perform a method.

Block 510 may include receiving, by an input-output (IO) device, a debug packet from a host system via an in-band connection, the IO device comprising an IO controller and a debug controller. Block 520 may include processing, by the debug controller, the debug packet to extract a command generated by the host system. Block 530 may include executing, by the debug controller, the extracted command to debug the IO device. After block 530, the method 500 is completed. For example, referring to FIG. 1A, the debug controller 180 may receive a debug packet 144 from the host system 110, and may extract a command from the received debug packet 144. The debug controller 180 may execute the extracted command to perform a debug action in the IO device 150. In some embodiments, the debug software 136 of the host system 110 may generate the command, and the debug interface 134 may encapsulate the command in the debug packet 144.

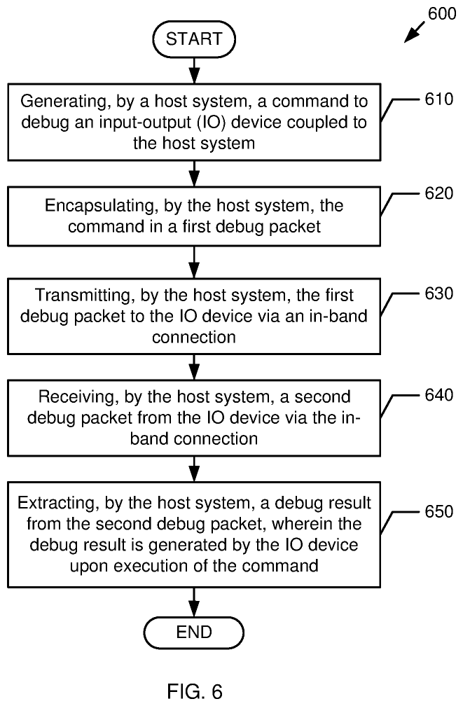

FIG. 6—Example Method

Referring now to FIG. 6, shown is a flow diagram of a method 600, in accordance with one or more embodiments. In various embodiments, the method 600 may be performed by processing logic (e.g., processor 130, debug interface 134, and/or debug software 136 shown in FIG. 1A) that may include hardware (e.g., processing device, circuitry, dedicated logic, programmable logic, microcode, etc.), software and/or firmware (e.g., instructions run on a processing device), or a combination thereof. In firmware or software embodiments, the method 600 may be implemented by computer executed instructions stored in a non-transitory machine-readable medium, such as an optical, semiconductor, or magnetic storage device. The machine-readable medium may store data, which if used by at least one machine, causes the at least one machine to fabricate at least one integrated circuit to perform a method.

Block 610 may include generating, by a host system, a command to debug an input-output (IO) device coupled to the host system. Block 620 may include encapsulating, by the host system, the command in a first debug packet. Block 630 may include transmitting, by the host system, the first debug packet to the IO device via an in-band connection. For example, referring to FIG. 1A, the debug software 136 of the host system 110 may generate a command to debug the IO device 150. The debug interface 134 may encapsulate the command in a debug packet 144, and may transmit the debug packet 144 to the IO device 150 via the link 140.

Block 640 may include receiving, by the host system, a second debug packet from the IO device via the in-band connection. Block 650 may include extracting, by the host system, a debug result from the second debug packet, wherein the debug result is generated by the IO device upon execution of the command. After block 650, the method 600 is completed. For example, referring to FIG. 1A, the debug controller 180 may receive the debug packet 144 from the host system 110, and may extract the command from the received debug packet 144. The debug controller 180 may execute the extracted command to perform a debug action in the IO device 150.

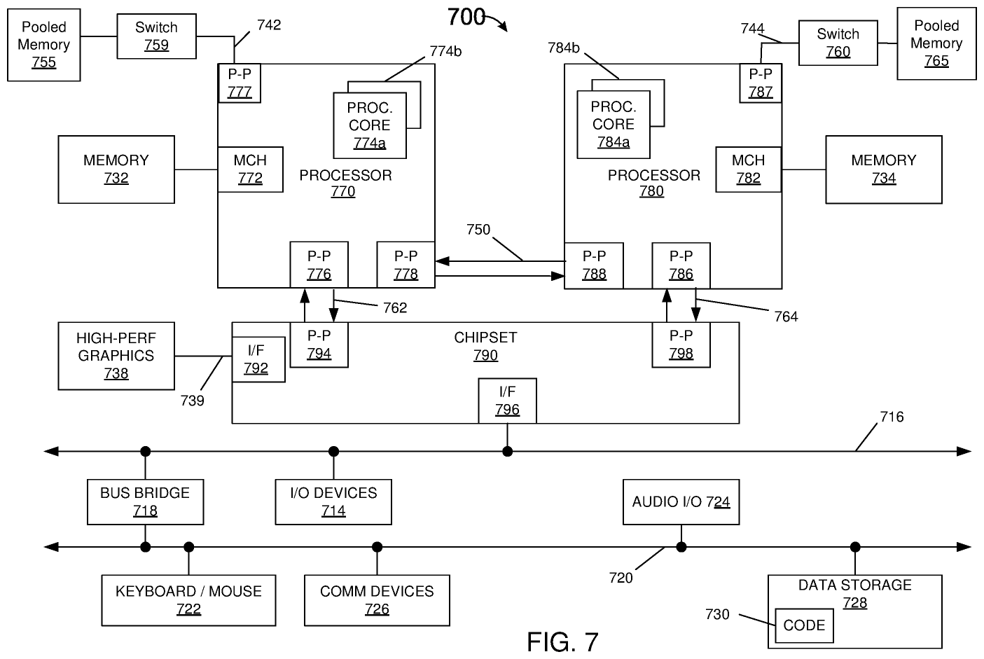

FIG. 7—Example System

Referring now to FIG. 7, shown is a block diagram of a system in accordance with another embodiment such as an edge platform. As shown in FIG. 7, multiprocessor system 700 includes a first processor 770 and a second processor 780 coupled via an interconnect 750, which in an embodiment can be an optical interconnect that communicates with optical circuitry (which may be included in or coupled to processors 770). As shown in FIG. 7, each of processors 770 and 780 may be many core processors including representative first and second processor cores (i.e., processor cores 774a and 774b and processor cores 784a and 784b).

In the embodiment of FIG. 7, processors 770 and 780 further include point-to point interconnects 777 and 787, which couple via interconnects 742 and 744 (which may be CXL buses) to switches 759 and 760. In turn, switches 759, 760 couple to pooled memories 755 and 765.

Still referring to FIG. 7, first processor 770 further includes a memory controller hub (MCH) 772 and point-to-point (P-P) interfaces 776 and 778. Similarly, second processor 780 includes a MCH 782 and P-P interfaces 786 and 788. As shown in FIG. 7, MCH's 772 and 782 couple the processors to respective memories, namely a memory 732 and a memory 734, which may be portions of system memory (e.g., DRAM) locally attached to the respective processors. First processor 770 and second processor 780 may be coupled to a chipset 790 via P-P interconnects 776 and 786, respectively. As shown in FIG. 7, chipset 790 includes P-P interfaces 794 and 798.

Furthermore, chipset 790 includes an interface 792 to couple chipset 790 with a high performance graphics engine 738, by a P-P interconnect 739. As shown in FIG. 7, various input/output (I/O) devices 714 may be coupled to first bus 716, along with a bus bridge 718 which couples first bus 716 to a second bus 720. Various devices may be coupled to second bus 720 including, for example, a keyboard/mouse 722, communication devices 726 and a data storage unit 728 such as a disk drive or other mass storage device which may include code 730, in one embodiment. Further, an audio I/O 724 may be coupled to second bus 720.

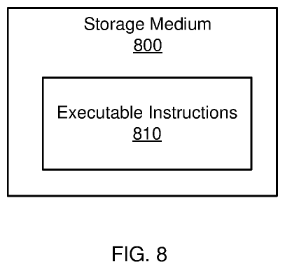

FIG. 8—Example Storage Medium

Referring now to FIG. 8, shown is a storage medium 800 storing executable instructions 810. In some embodiments, the storage medium 800 may be a non-transitory machine-readable medium, such as an optical medium, a semiconductor, a magnetic storage device, and so forth. The executable instructions 810 may be executable by a processing device. Further, the executable instructions 810 may be used by at least one machine to fabricate at least one integrated circuit to perform one or more of the methods and/or operations shown in FIGS. 1-6.

The following clauses and/or examples pertain to further embodiments.

In Example 1, an input-output (IO) device for debugging includes an IO controller coupled to a debug controller. The Io IO controller is to process IO data packets. The debug controller is to: receive a first debug packet from a host system via an in-band connection; process the first debug packet to extract a command generated by the host system; and execute the extracted command to debug the IO device.

In Example 2, the subject matter of Example 1 may optionally include that debug controller is to: obtain a debug result from an execution of the extracted command; encapsulate the debug result in a second debug packet; and transmit the second debug packet to the host system.

In Example 3, the subject matter of Examples 1-2 may optionally include that the debug controller is to, prior to a receipt of the first debug packet: receive a debug request from the host system; determine whether the debug request is authorized; and in response to a determination that the debug request is authorized, unlock a debug mode of the IO device and transmit a confirmation of the debug request to the host system.

In Example 4, the subject matter of Examples 1-3 may optionally include that the debug request comprises a secure token to indicate a debug type and a debug level, and that the host system is to generate the first debug packet in response to a receipt of the confirmation from the IO device.

In Example 5, the subject matter of Examples 1-4 may optionally include: a first power domain to provide electrical power to the IO controller; and a second power domain to provide electrical power to the debug controller, where the second power domain is to remain powered when the first power domain is not powered.

In Example 6, the subject matter of Examples 1-5 may optionally include that the IO device is one selected from a Universal Serial Bus (USB) host, a USB hub, and a USB device.

In Example 7, the subject matter of Examples 1-6 may optionally include that the debug controller is to execute the extracted command to pause an execution of the IO controller.

In Example 8, the subject matter of Examples 1-7 may optionally include an in-band port to transfer a plurality of IO data packets and a plurality of debug packets.

In Example 9, the subject matter of Examples 1-8 may optionally include at least one additional component, where the debug controller is to execute the extracted command to debug the at least one additional component.

In Example 10, a method for debugging may include: receiving, by an input-output (IO) device, a first debug packet from a host system via an in-band connection, the IO device comprising an IO controller and a debug controller; processing, by the debug controller, the first debug packet to extract a command generated by the host system; and executing, by the debug controller, the extracted command to debug the IO device.

In Example 11, the subject matter of Example 10 may optionally include: obtaining, by the debug controller, a debug result from an execution of the extracted command; encapsulating, by the debug controller, the debug results in a second debug packet; and transmitting, by the debug controller, the second debug packet to the host system.

In Example 12, the subject matter of Examples 10-11 may optionally include, prior to a receipt of the first debug packet: receiving, by the debug controller, a debug request from the host system; determining, by the debug controller, whether the debug request is authorized; and in response to a determination that the debug request is authorized: unlocking, by the debug controller, a debug mode of the IO device; and transmitting, by the debug controller, a confirmation of the debug request to the host system.

In Example 13, the subject matter of Examples 10-12 may optionally include: receiving, by the host system from the debug controller, the confirmation of the debug request; generating, by the host system, the command in response to a receipt of the confirmation; and encapsulating, by the host system, the command the first debug packet in response to a receipt of the confirmation.

In Example 14, the subject matter of Examples 10-13 may optionally include: processing, by the IO controller of the IO device, a plurality of IO data packets; processing, by the debug controller of the IO device, a plurality of debug packets; and transmitting the plurality of IO data packets and the plurality of debug packets using an in-band port of the IO device.

In Example 15, the subject matter of Examples 10-14 may optionally include that executing the extracted command by the debug controller comprises pausing an execution of the IO controller.

In Example 16, a computing device may include: one or more processors; and a memory having stored therein a plurality of instructions that when executed by the one or more processors, cause the computing device to perform the method of any of Examples 10 to 15.

In Example 17, a machine readable medium may have stored thereon data, which if used by at least one machine, causes the at least one machine to fabricate at least one integrated circuit to perform a method according to any one of Examples 10 to 15.

In Example 18, an electronic device may include means for performing the method of any of Examples 10 to 15.

In Example 19, a system for debugging may include a host system and an input-output (IO) device. The IO) device may include: an IO controller to process IO data packets, and a debug controller coupled to the IO controller. The debug controller may be to receive a first debug packet from a host system via an in-band connection, process the first debug packet to extract a command generated by the host system, and execute the extracted command to debug the IO device.

In Example 20, the subject matter of Example 19 may optionally include 20 that the debug controller is to: obtain a debug result from an execution of the extracted command; encapsulate the debug result in a second debug packet; and transmit the second debug packet to the host system.

In Example 21, the subject matter of Examples 19-20 may optionally include that the debug controller is to, prior to a receipt of the first debug packet: receive a debug request from the host system; determine whether the debug request is authorized; and in response to a determination that the debug request is authorized: unlock a debug mode of the IO device; and transmit a confirmation of the debug request to the host system.

In Example 22, the subject matter of Examples 19-21 may optionally include that the debug request comprises a secure token to indicate a debug type and a debug level, and that the host system is to generate the first debug packet in response to a receipt of the confirmation from the IO device.

In Example 23, the subject matter of Examples 19-22 may optionally include that the IO device comprises a first power domain to provide electrical power to the IO controller; and a second power domain to provide electrical power to the debug controller, where the second power domain is to remain powered when the first power domain is not powered.

In Example 24, an apparatus for debugging may include: means for receiving, by an input-output (IO) device, a first debug packet from a host system via an in-band connection, the IO device comprising an IO controller and a debug controller; means for processing the first debug packet to extract a command generated by the host system; and means for executing the extracted command to debug the IO device.

In Example 25, the subject matter of Example 24 may optionally include: means for obtaining a debug result from an execution of the extracted command; means for encapsulating the debug results in a second debug packet; and means for transmitting the second debug packet from the debug controller to the host system.

In Example 26, the subject matter of Examples 24-25 may optionally include: means for receiving a debug request from the host system; means for determining whether the debug request is authorized; and means for, in response to a determination that the debug request is authorized: unlocking a debug mode of the IO device; and transmitting a confirmation of the debug request to the host system.

In Example 27, the subject matter of Examples 24-26 may optionally include: means for receiving the confirmation of the debug request; means for generating the command in response to a receipt of the confirmation; and means for encapsulating the command the first debug packet in response to a receipt of the confirmation.

In Example 28, the subject matter of Examples 24-27 may optionally include: means for processing a plurality of IO data packets; means for processing a plurality of debug packets; and means for transmitting the plurality of IO data packets and the plurality of debug packets using an in-band port of the IO device.

In Example 29, the subject matter of Examples 24-28 may optionally include that the means for executing the extracted command by the debug controller comprises means for pausing an execution of the IO controller.

In some embodiments described herein, an IO device may include a debug controller to receive debug packets including debug commands from a host system via an in-band connection. The debug controller may extract the command from the received packet, and may then execute the command to perform debug actions in the IO device. The debug controller may obtain the results of the executed command, encapsulate the results in another debug packet, and transmit the debug packet to the host system via the in-band connection. Upon receiving the debug packet, the host system may extract the results from the debug packet, and may use the results in the debugging process. In this manner, some embodiments may provide in-band debugging of IO devices that includes run-control capabilities. Accordingly, one or more embodiments may perform advanced debug actions without requiring separate out-of-band connections or device modifications, and may therefore reduce the cost and complexity associated with debugging IO devices.

Note that, while FIGS. 1-8 illustrate various example implementations, other variations are possible. For example, the examples shown in FIGS. 1-8 are provided for the sake of illustration, and are not intended to limit any embodiments. Specifically, while embodiments may be shown in simplified form for the sake of clarity, embodiments may include any number and/or arrangement of components. For example, it is contemplated that some embodiments may include any number of components in addition to those shown, and that different arrangement of the components shown may occur in certain implementations. Furthermore, it is contemplated that specifics in the examples shown in FIGS. 1-8 may be used anywhere in one or more embodiments.

Understand that various combinations of the above examples are possible. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An input-output (IO) device comprising:
an IO controller to process IO data packets; and
a debug controller coupled to the IO controller, the debug controller to:
receive a first debug packet from a host system via an in-band connection;
process the first debug packet to extract a command generated by the host system; and
execute the extracted command to debug the IO device.

2. The IO device of claim 1, wherein the debug controller is to:
obtain a debug result from an execution of the extracted command;
encapsulate the debug result in a second debug packet; and
transmit the second debug packet to the host system.

3. The IO device of claim 1, wherein the debug controller is to, prior to a receipt of the first debug packet:
receive a debug request from the host system;
determine whether the debug request is authorized; and
in response to a determination that the debug request is authorized:
unlock a debug mode of the IO device; and
transmit a confirmation of the debug request to the host system.

4. The IO device of claim 3, wherein the debug request comprises a secure token to indicate a debug type and a debug level, and wherein the host system is to generate the first debug packet in response to a receipt of the confirmation from the IO device.

5. The IO device of claim 1, further comprising:
a first power domain to provide electrical power to the IO controller; and
a second power domain to provide electrical power to the debug controller,
wherein the second power domain is to remain powered when the first power domain is not powered.

6. The IO device of claim 1, wherein the IO device is one selected from a Universal Serial Bus (USB) host, a USB hub, and a USB device.

7. The IO device of claim 1, wherein the debug controller is to execute the extracted command to pause an execution of the IO controller.

8. The IO device of claim 1, further comprising an in-band port to transfer a plurality of IO data packets and a plurality of debug packets.

9. The IO device of claim 1, further comprising at least one additional component, wherein the debug controller is to execute the extracted command to debug the at least one additional component.

10. A method comprising:
receiving, by an input-output (IO) device, a first debug packet from a host system via an in-band connection, the IO device comprising an IO controller and a debug controller;
processing, by the debug controller, the first debug packet to extract a command generated by the host system; and
executing, by the debug controller, the extracted command to debug the IO device.

11. The method of claim 10, comprising:
obtaining, by the debug controller, a debug result from an execution of the extracted command;
encapsulating, by the debug controller, the debug results in a second debug packet; and
transmitting, by the debug controller, the second debug packet to the host system.

12. The method of claim 10, comprising, prior to a receipt of the first debug packet:
receiving, by the debug controller, a debug request from the host system;
determining, by the debug controller, whether the debug request is authorized; and
in response to a determination that the debug request is authorized:
unlocking, by the debug controller, a debug mode of the IO device; and
transmitting, by the debug controller, a confirmation of the debug request to the host system.

13. The method of claim 12, comprising:
receiving, by the host system from the debug controller, the confirmation of the debug request;
generating, by the host system, the command in response to a receipt of the confirmation; and
encapsulating, by the host system, the command the first debug packet in response to a receipt of the confirmation.

14. The method of claim 10, comprising:
processing, by the IO controller of the IO device, a plurality of IO data packets;
processing, by the debug controller of the IO device, a plurality of debug packets; and
transmitting the plurality of IO data packets and the plurality of debug packets using an in-band port of the IO device.

15. The method of claim 10, wherein executing the extracted command by the debug controller comprises pausing an execution of the IO controller.

16. A system comprising:
A host system; and
an input-output (IO) device comprising:
an IO controller to process IO data packets; and
a debug controller coupled to the IO controller, the debug controller to receive a first debug packet from a host system via an in-band connection, process the first debug packet to extract a command generated by the host system, and execute the extracted command to debug the IO device.

17. The system of claim 16, wherein the debug controller is to:
obtain a debug result from an execution of the extracted command;
encapsulate the debug result in a second debug packet; and
transmit the second debug packet to the host system.

18. The system of claim 16, wherein the debug controller is to, prior to a receipt of the first debug packet:
receive a debug request from the host system;
determine whether the debug request is authorized; and
in response to a determination that the debug request is authorized:
unlock a debug mode of the IO device; and
transmit a confirmation of the debug request to the host system.

19. The system of claim 18, wherein the debug request comprises a secure token to indicate a debug type and a debug level, and wherein the host system is to generate the first debug packet in response to a receipt of the confirmation from the IO device.

20. The system of claim 16, wherein the IO device further comprises:
a first power domain to provide electrical power to the IO controller; and
a second power domain to provide electrical power to the debug controller,
wherein the second power domain is to remain powered when the first power domain is not powered.
